(19) United States
(12) Patent Application Publication
(10) Pub. No.: US 2015/0022369 A1
(43) Pub. Date: Jan. 22, 2015

(54) NOTEBOOK COMPUTER WITH PERIPHERAL CONNECTIONS INDICATOR

(71) Applicant: HON HAI PRECISION INDUSTRY CO., LTD., New Taipei (TW)

(72) Inventors: Wei-Shih Chen, New Taipei (TW); Shu-Yuan Kuo, New Taipei (TW)

(21) Appl. No.: 14/333,731

(22) Filed: Jul. 17, 2014

(30) Foreign Application Priority Data
Jul. 18, 2013 (TW) 102125789

(51) Int. Cl. G06F 11/32; G08B 5/36; G06F 1/16

(52) U.S. Cl. CPC G06F 11/325; G06F 1/1633; G08B 5/36
USPC 340/815.4

(57) ABSTRACT

A notebook structure with visual indicators of the presence and activity of peripheral interfaces can include a top cover, a middle portion attached to the top cover and a label panel. The middle portion can include a circuit board and a plurality of input and output interfaces secured to the circuit board. The label panel defining a plurality of input and output icons can be attached to the top cover and adjacent to the plurality of input and output interfaces so as to indicate respective locations of each interface. The label panel is configured to illuminate the plurality of input and output icons.

### CROSS-REFERENCE TO RELATED APPLICATIONS

This application claims priority to Taiwan Patent Application No. 102125789 filed on Jul. 18, 2013 in the Taiwan Intellectual Property Office, the contents of which are hereby incorporated by reference.

### FIELD

The present disclosure relates to notebook computers, and more particularly a notebook computer with a peripheral connectors indicator.

### BACKGROUND

Notebook computers can include a plurality of input and output interfaces for connecting to different peripheral devices, such as Universal Serial Buses (USBs), High-Definition Multimedia Interfaces (HDMIs), and so on. The peripheral devices are usually inserted into wrong interfaces without indicator.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a notebook computer of a notebook computer.

FIG. 2 is a side view of the notebook computer of the notebook computer of FIG. 1.

FIG. 3 is an assembled view of the notebook computer of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

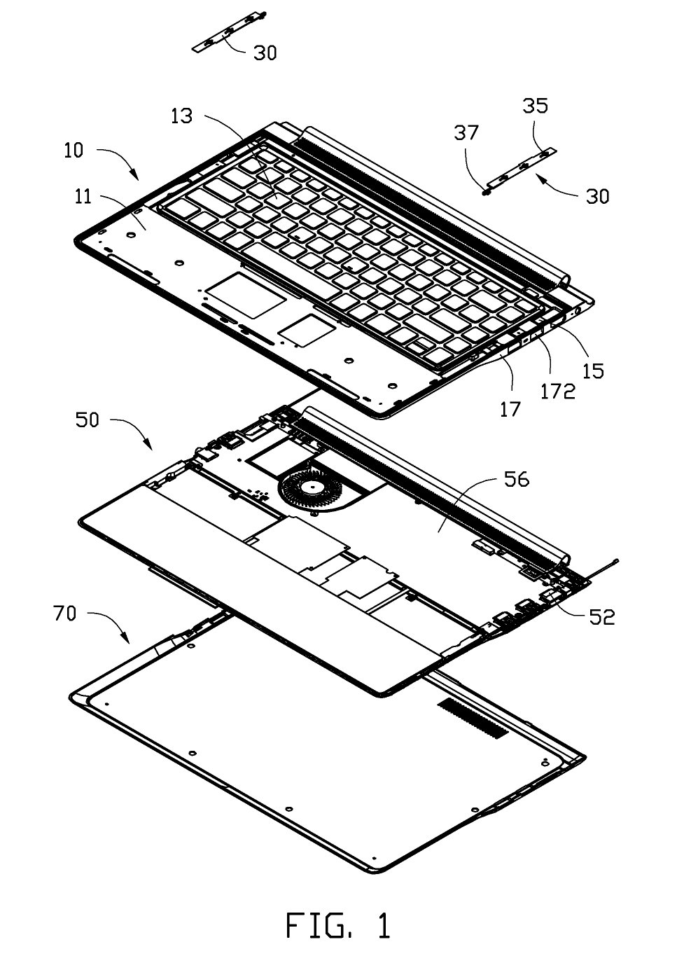

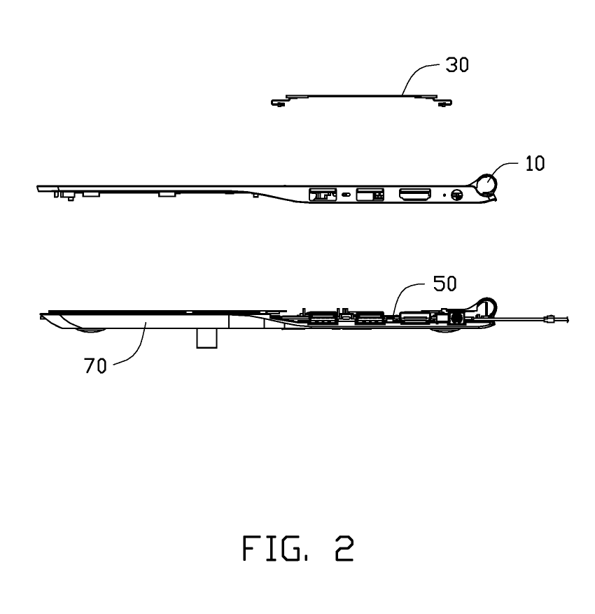

FIGS. 1 and 2 illustrate part of the structure of a notebook computer in accordance with an embodiment. The notebook computer can include a top cover 10, two label panels 30, a middle portion 50, and a bottom cover 70.

The top cover 10 can include a decorating board 11 and a keyboard 13 accommodated in the decorating board 11. The decorating board 11 can include two installation areas 15 and two sidewalls 17. The two installation areas 15 can be positioned on opposite sides of the keyboard 13. Each of the two sidewalls 17 can be connected to each of the two installation areas 15 and each sidewall 17 can define a plurality of openings 172.

The middle portion 50 can be attached to the top cover 10 and can include a circuit board 56 and a plurality of input and output interfaces 52. The plurality of input and output interfaces 52 can be secured to the circuit board 56 and located at opposite edges of the circuit board 56. The plurality of input and output interfaces 52 positioned on each edge is located in a line, and each of the plurality of input and output interfaces 52 has an extending direction. The extending direction is substantially perpendicular to the line.

Each of the two label panels 30 can be attached to each of the two installation areas 15 of the decorating board 11 and can be electrically coupled to circuit board 56 via two connectors 37. The label panel 30 can be an electro-luminescent (EL) sheet and can be substantially rectangular. A plurality of input and output icons 35 is defined in the label panel 30. An input and output icon 35 is configured to indicate a type of interface, being a Universal Serial Bus (USB), a High-Definition Multimedia Interface (HDMI), and so on. Each of the plurality of input and output icons 35 is configured to indicate a location of one of the plurality of input and output interfaces 52, and the label panel 30 is configured to illuminate the plurality of input and output icons 52. A thickness of the label panel 30 is substantially less than or equal to 0.7 mm. In one embodiment, the thickness of the label panel 30 is 0.11 mm.

In one embodiment, an electro-luminescent device is a device for converting electric energy into light energy and made of phosphor particles. The phosphor particles comprise fluorescent materials and zinc sulfide. An alternating voltage between the phosphor particle des can excite the particles of zinc sulfide, to generate an alternating electric field. Electrons of the particles are given high speed in a light-emitting layer. Atoms in the fluorescent materials are activated to be accelerated so that the atoms can get additional energy. The fast-moving electrons can hit the atoms to emit light very efficiently.

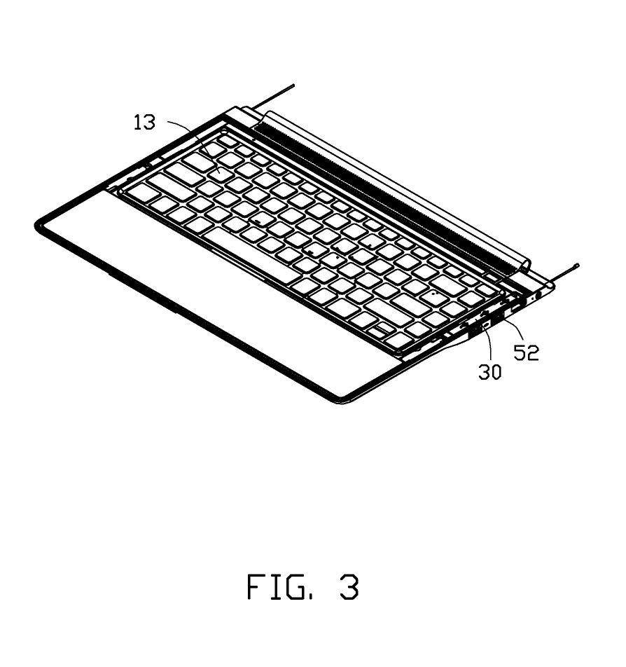

FIG. 3 illustrates assembly, in which the label panels 30 are attached on the installation areas 15 (shown in FIG. 1). The top cover 10 (shown in FIG. 1) is engaged with the bottom cover 70 (shown in FIG. 1) to secure the middle portion 50 (shown in FIG. 1) therebetween. Each of the plurality of input and output interfaces 52 is engaged in each of the plurality of openings 172 (shown in FIG. 1). The position of each of the plurality of input and output icons 35 (shown in FIG. 1) is aligned with the position of each of the plurality of input and output interfaces 52 and configured to indicate the location of an input and output interface 52. The extension direction of each of the plurality of input and output interfaces 52 is substantially parallel to the label panel 30.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure. The described embodiments herein are illustrative, and should not be construed as limiting the following claims.

What is claimed is:

1. A notebook computer comprising:
a top cover;
a middle portion attached to the top cover, the middle portion comprising a circuit board and a plurality of input and output interfaces secured to the circuit board; and
a label panel attached to the top cover and adjacent to the plurality of input and output interfaces, and a plurality of input and output icons being defined in the label panel, wherein the plurality of input and output icons is configured to indicate the plurality of input and output interfaces, and the label panel is configured to illuminate the plurality of input and output icons, to indicate each input and output interface.

2. The notebook computer of claim 1, wherein the label panel is an electro-luminescent sheet.

3. The notebook computer of claim 2, wherein a thickness of the label panel is substantially smaller than or equal to 0.7 mm.

4. The notebook computer of claim 3, wherein the thickness of the label panel is about 0.11 mm.

5. The notebook computer of claim 4, wherein the top cover comprises a decorating board and a keyboard accommodated in the decorating board, and the label panel is attached to the decorating board and positioned on one side of the keyboard.

6. The notebook computer of claim 4, wherein each of the plurality of input and output interfaces has an extension direction, and the extension direction is substantially parallel to the label panel.

7. The notebook computer of claim 4, further comprising a bottom cover, wherein the middle portion is located between the top cover and the bottom cover, and the top cover is engaged with the bottom cover.

8. The notebook computer of claim 4, wherein the circuit board is electrically coupled to the label panel.

9. The notebook computer of claim 6, wherein the plurality of the input and output interfaces is located in a same line, and the line is substantially perpendicular to the extension direction.

10. The notebook computer of claim 8, wherein the label panel is substantially rectangular.

11. A notebook computer, comprising:
a top cover comprising a decorating board, and the decorating board defining a plurality of opening;
a middle portion attached to the top cover, the middle portion comprising a circuit board and a plurality of input and output interfaces secured to the circuit board, each of plurality of input and output interface being engaged in each of the plurality of opening; and
a label panel attached to the decorating and electrically coupled to the circuit board, and a plurality of input and output icons being defined in the label panel, wherein the plurality of input and output icons is configured to indicate the plurality of input and output interfaces, and the label panel is configured to illuminate the plurality of input and output icons.

12. The notebook computer of claim 11, wherein the label panel is an electro-luminescent sheet.

13. The notebook computer of claim 12, wherein a thickness of the label panel is substantially smaller than or equal to 0.7 mm.

14. The notebook computer of claim 13, wherein the thickness of the label panel is 0.11 mm.

15. The notebook computer of claim 14, wherein the top cover further comprises a keyboard accommodated in the decorating board, and the label panel is located in one side of the keyboard.

16. The notebook computer of claim 14, wherein each of the plurality of input and output interfaces has an extension direction, and the extension direction is substantially parallel to the label panel.

17. The notebook computer of claim 14, further comprising a bottom cover, wherein the middle portion is located between the top cover and the bottom cover, and the top cover is engaged with the bottom cover.

18. The notebook computer of claim 16, wherein the plurality of the input and output interfaces is located in a same line, and the line is substantially perpendicular to the extension direction.

19. The notebook computer of claim 18, wherein the label panel is substantially rectangular.
